(19) United States
(12) Patent Application Publication
(10) Pub. No.: US 2007/0294195 A1
(43) Pub. Date: Dec. 20, 2007

(54) METHODS OF DETERRING, DETECTING, AND MITIGATING FRAUD BY MONITORING BEHAVIORS AND ACTIVITIES OF AN INDIVIDUAL AND/OR INDIVIDUALS WITHIN AN ORGANIZATION

(76) Inventors: Edith L. CURRY, Glen Allen, VA (US); Frank HAILSTONES, Orlando, FL (US); Michael A. DEMENT, Williamsburg, VA (US); Laurie S. HOLTZ, Miami Beach, FL (US)

Correspondence Address: HAHN LOESER & PARKS, LLP, One GOJO Plaza, Suite 300, AKRON, OH, 44311-1076, US

(21) Appl. No.: 11/536,084

(22) Filed: Sep. 28, 2006

Related U.S. Application Data
(63) Continuation-in-part of application No. 11/424,086, filed on Jun. 14, 2006.

(51) Int. Cl. G06F 19/00

(52) U.S. Cl. 705/500

(57) ABSTRACT

A cooperative arrangement and method to help deter and/or detect and/or mitigate fraud by evaluating and then monitoring the information of an individual or individuals for changes in fraud risk. A personal information disclosure statement, personal information records, and other relevant information associated with an individual, or a plurality of individuals, associated with an organization, an individual potentially to be associated with an organization, or an individual acting in his or her individual capacity are obtained. Information is extracted from the personal information disclosure statement, the personal information records, and the other relevant information and entered into a risk assessment algorithm. The risk assessment algorithm operates on the entered information and generates risk assessment data. The risk assessment data is evaluated to make a determination of fraud risk with respect to the individual(s). A decision to provide a fraud risk determination means that the risk associated with the individual, with respect to committing fraud, is acceptable. Risk assessment data on a plurality of key individuals within an organization may be generated and evaluated to make a determination of fraud risk with respect to the organization itself.

### CROSS-REFERENCE TO RELATED APPLICATIONS/INCORPORATION BY REFERENCE

This U.S. patent application is a continuation-in-part (CIP) of pending U.S. patent application Ser. No. 11/424,086 filed on Jun. 14, 2006.

### TECHNICAL FIELD

Certain embodiments of the present invention relate to organizational behavior such as, for example, behavior of an individual when operating within a legal entity such as a corporation. More particularly, certain embodiments of the present invention relate to methods of deterring and/or detecting and/or mitigating fraud within an organization by identifying and reducing the risks of financial self-dealing and self-enrichment associated with the people who are responsible for various aspects of the organization.

### BACKGROUND OF THE INVENTION

Fraud is perpetrated by individuals, and their behaviors and activities can indicate that they have committed, and provide leading indicators that they will commit, fraud. How an individual earns, saves, invests, manages, and spends money are key factors. Typically, fraud begins with the individual telling himself, “ . . . just this once, I'll pay it back.” But once that line is crossed, the individual rarely turns back. It becomes easier and easier for the individual to justify the fraudulent behavior/acts, with the amount defrauded steadily increasing before being detected, if at all.

One source of the problem stems from the leadership of organizations (e.g., board of directors and senior management). For example, a passive, non-independent, and rubber-stamping board of directors composed of members selected by the CEO or chairman of the board does not guarantee effective oversight of management actions and conduct.

Moreover, management teams that place personal interests above creating value for the organization and its investors when conducting the affairs of the corporation incur a systemic conflict of interest, In the past, breaches of fiduciary duty by management and boards of directors were sometimes condoned by auditors who lacked independence and possessed limited capability and authority to challenge management.

The Sarbanes-Oxley Act (SOA) of 2002 was designed to protect shareholders and workers and gave the federal government new powers to enforce corporate responsibility and to improve oversight of publicly traded corporations. This legislation gave new power to prosecutors and regulators seeking to improve corporate responsibility and protect shareholders and workers. Among other reforms, the legislation:
increased the accountability of officers and directors;
   created a new securities fraud provision with a 25-year maximum term of imprisonment;
directed the Sentencing Commission to review sentencing in white collar crime, obstruction of justice, securities, accounting, and pension fraud cases;
   required CEOs and Chief Financial Officers (CFOs) to certify personally financial reports submitted to the U.S. Securities and Exchange Commission fully comply with securities laws and fairly present, in all material respects, the financial condition of their companies;
criminalized retaliatory conduct directed at corporate whistleblowers and others.

The Sarbanes-Oxley Act places considerable emphasis on correcting lax corporate governance practices, including:
management dealing in an environment rife with conflicts of interest;
lack of strict transparency, reliability, and accuracy standards in financial reporting;
lack of independence of key players in corporate governance, beginning with the board of directors, senior management, and auditors;
lack of adequate enforcement tools for regulators; and
widespread conflicts of interest influencing securities market transactions.

Addressing the systemic weakness of the corporate governance practices in the post-Sarbanes-Oxley corporate environment requires more than correcting the most visible manifestations of the problem.

Laws and regulations have always proven to be insufficient to guarantee society's welfare or, in this case, improvement in corporate governance standards. In many ways, Sarbanes-Oxley has merely made express the duties and responsibilities of boards, CEOs, and CFOs and taken away from them the ability to blame someone else if fraud and abuse occur at a company covered by Sarbanes-Oxley. However, these duties existed before Sarbanes-Oxley was enacted, albeit in less explicit fashion. While it may be comforting to some that Sarbanes-Oxley has eliminated the ability of senior management to claim they did not know or were not aware, this is still unlikely to prevent people from committing the types of fraud and abuse that led to the passage of Sarbanes-Oxley in the first place.

While Sarbanes-Oxley will play a role in ensuring that U.S. companies avoid certain excesses, the market and investors should continue to seek out solutions that are driven by market needs that help restore and maintain the confidence of investors in public companies.

Accountability is the key in any type of organization. The owners of public corporations (i.e., the shareholders) must hold managers, directors, and auditors accountable. The performance of these groups directly impacts shareholder value. The corporate governance process must guarantee performance excellence by management and the board of directors.

Members, shareholders, investors, and tax payers must hold the leaders of private companies, not-for-profit entities, and even governmental bodies accountable, as well. The performance of these leaders directly impacts the value of their organizations. Their governance processes must guarantee performance excellence by the organizations' leaders.

Although implementing corporate governance best practices can result in additional operating costs, good corporate governance is not an option but an obligation, if shareholder interest is to be protected. Compliance costs are only a small fraction of the large losses suffered by stockholders when boards and/or executive management do not comply with good corporate governance practices. Sarbanes-Oxley has taken great steps at ensuring proper corporate governance and has put some teeth into non-compliance penalties for boards and management.

Sarbanes-Oxley was a good first step in combating abuses. However, additional protections should be put in place to complement Sarbanes-Oxely and more directly address those problems which Sarbanes-Oxley, by itself, cannot solve such as, for example, fraud prevention.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention is a method to help deter and/or detect and/or mitigate fraud by evaluating the propensity of an individual associated with an organization, an individual potentially to be associated with an organization, or an individual acting in his or her individual capacity to commit fraud. The method includes obtaining a personal information disclosure statement of the individual and also obtaining personal information records and other relevant information about that individual. The method further includes entering nformation from the personal information disclosure statement, the personal information records, and the other relevant information into a risk assessment algorithm. The method also includes the risk assessment algorithm operating on the entered information and thereby generating risk assessment data. The method further includes evaluating the risk assessment data and thereby making a determination of the level of fraud risk that that individual poses. This determination can be in the form of a quantitative score, a qualitative assignment to a risk category (with flexible and/or rigid thresholds), a certification, or a similar representation that indicates a relative likelihood of the individual committing fraud. Such a determination may be publicly disclosed or kept confidential, depending on the intended use by individuals or organizations.

Another embodiment of the present invention is a method to help deter and/or detect and/or mitigate fraud by evaluating the propensity of an organization to commit fraud. The method includes obtaining a personal information disclosure statement, personal information records, and other relevant information for each of a plurality of individuals associated with the organization. The method further includes entering information from each of the personal information disclosure statements, each of the personal information records, and each of the other relevant information into a risk assessment algorithm. The method also includes the risk assessment algorithm operating on the entered information and thereby generating risk assessment data. The method further includes evaluating the risk assessment data and thereby making a determination of the level of fraud risk that that organization poses. The determination can be in the form of a quantitative score, a qualitative assignment to a risk category (with flexible and/or rigid thresholds), a certification, or a similar representation that indicates a relative likelihood of the organization committing fraud. The determination may be publicly disclosed or kept confidential, depending on the intended use by individuals or organizations.

A further embodiment of the present invention is a method to help deter and/or detect and/or mitigate fraud by monitoring the information of an individual, or a plurality of individuals, associated with an organization, an individual potentially to be associated with an organization, or an individual acting in his or her individual capacity for changes in fraud risk. The method includes frequently and/or periodically obtaining updated personal information records and other relevant information of individuals whose level of fraud risk has previously been determined. The method further includes entering into a risk assessment algorithm this updated information from the personal information records and other relevant information. The method also includes the risk assessment algorithm operating on the input information and the previously entered information from the previously obtained personal information disclosure statement of the individual person and thereby generating updated risk assessment data. The method further includes evaluating the updated risk assessment data and thereby making an updated determination of the level of fraud risk the individual person or organization poses. The determination can be in the form of a quantitative score, a qualitative assignment to a risk category (with flexible and/or rigid thresholds), a certification, or a similar representation that indicates a relative likelihood of the individual committing fraud. The determination may be publicly disclosed or kept confidential, depending on the intended use by individuals or organizations.

If, at any time during the period in which an individual is in process of receiving, or has already received, a determination of the level of fraud risk the individual or organization poses, issues of concern are identified, the corresponding concern may be investigated for accuracy and, depending on the results of the investigation, the determination of the level of fraud risk posed may be suspended, cancelled, changed, or left unchanged. The entity providing the determination of the level of fraud risk posed, in accordance with an embodiment of the present invention, is an evaluator of risk. The oversight and independent monitoring of individuals and/or organizations are provided, thereby identifying the level of fraud risk posed by those individuals and/or organizations. Certain embodiments of the present invention use risk models which are based on a complex algorithm of predictive financial modeling.

These and other advantages and novel features of the present invention, as well as details of illustrated embodiments thereof, will be more fully understood from the following description and drawings.

### BRIEF DESCRIPTION OF SEVERAL VIEWS OF THE DRAWINGS

FIG. 1 is a functional block diagram of an embodiment of a cooperative arrangement to help deter and/or detect and/or mitigate fraud by evaluating the propensity of people to commit fraud, in accordance with various aspects of the present invention.

FIG. 2 illustrates a flowchart of a first embodiment of a method to help deter and/or detect and/or mitigate fraud by evaluating the propensity of an individual associated with an organization, an individual potentially to be associated with an organization, or an individual acting in his or her individual capacity to commit fraud, using the cooperative arrangement of FIG. 1, in accordance with various aspects of the present invention.

FIG. 3 illustrates a flowchart of a second embodiment of a method to help deter and/or detect and/or mitigate fraud by evaluating the propensity of an organization to commit fraud, using the cooperative arrangement of FIG. 1, in accordance with various aspects of the present invention.

FIG. 4 illustrates a flowchart of a third embodiment of a method to help deter and/or detect and/or mitigate fraud by monitoring the information of an individual, or a plurality of individuals, associated with an organization, an individual potentially to be associated with an organization, an individual acting in his or her individual capacity for changes in fraud risk, using the cooperative arrangement of FIG. 1, in accordance with various aspects of the present invention.

### DETAILED DESCRIPTION OF THE INVENTION

As used herein, the term “organization” generally refers to a publicly held corporation, a non-publicly held corporation, a private business, a for-profit business, a not-for-profit entity, a government entity, a non-governmental entity, an athletic organization, or any other type of organization where it may be desirable to implement embodiments of the present invention. As used herein, the term “individual” refers to any individual person in, being considered for being placed in, or could be placed in, a position of responsibility and/or trust with respect to an organization, including, but not limited to, an officer of the organization, an employee of the organization, a prospective employee or member of an organization, a member of the board of directors of an organization, a major stockholder of the organization, an athlete, and anyone who has the ability to over-ride governance, policies, procedures, and/or controls of the organization, or who has the ability to over-ride public laws or good practices. As used herein, the term “risk” generally refers to the likelihood of an individual to commit fraud. As used herein, the term “independent” means not associated with another entity in terms of ownership or control.

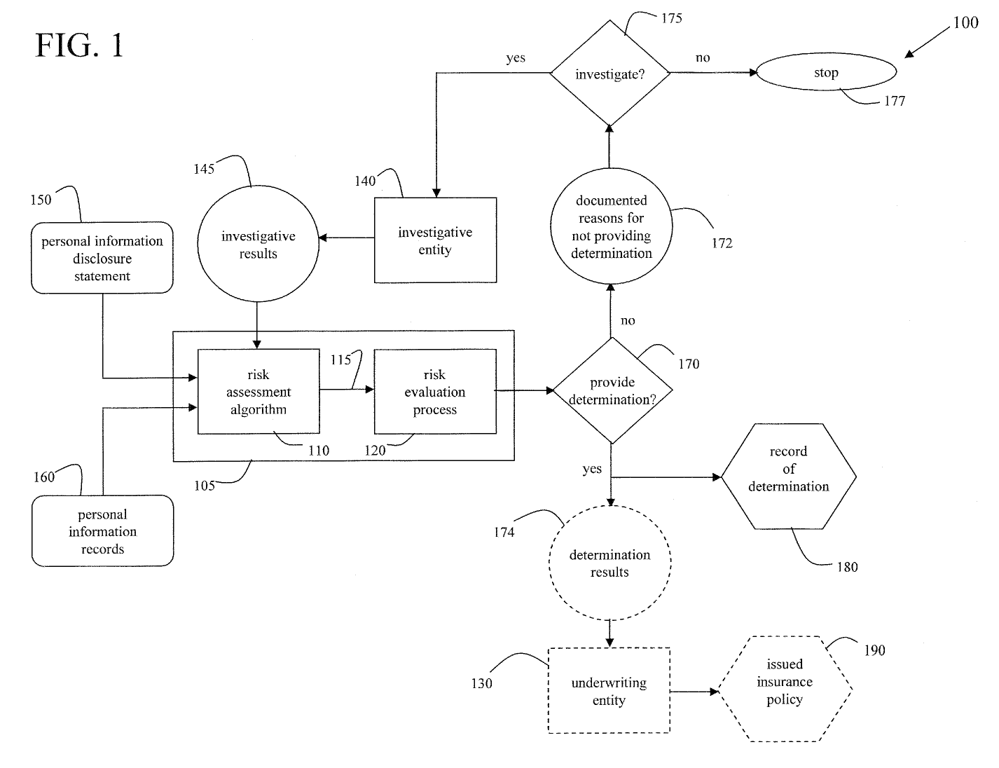

FIG. 1 is a functional block diagram of an embodiment of a cooperative arrangement 100 to help deter and/or detect and/or mitigate fraud by evaluating the propensity of people to commit fraud, in accordance with various aspects of the present invention. The cooperative arrangement 100 includes a fraud risk evaluation entity 105 which includes a risk assessment algorithm 110 and a risk evaluation process 120. The cooperative arrangement 100 further includes an underwriting entity 130, as an option, and an investigative entity 140. The risk assessment algorithm 110 is adapted to accept information from at least one personal information disclosure statement 150 and at least one set of personal information records 160 and other relevant information. Each personal information disclosure statement 150 and each set of personal information records 160 and other relevant information is associated with one individual person. In accordance with certain embodiments of the present invention, the individual may choose whether to proceed with the fraud risk determination process. That is, the individual may or may not give his informed consent to engage in the determination process and may or may not give permissive use of his or her information records and data.

In accordance with an embodiment of the present invention, the risk evaluation entity 105 may be independent of the individual whose propensity to commit fraud is to be determined. The risk assessment algorithm 110 operates on the input information from the personal information disclosure statement(s) 150 and the set(s) of personal information records 160 and other relevant information and generates risk assessment data 115. The risk that is being assessed is the likelihood that an individual will attempt to commit fraud. The risk assessment data 115 is entered into the fraud risk evaluation process 120. The risk evaluation process 120 evaluates the risk assessment data 115 to make a determination of risk 170 with respect to one of an individual or to an organization.

If the decision is made to provide the determination 170, then the fraud risk determination is created. The determination may take the form of a quantitative score, a qualitative assignment to a risk category (with flexible and/or rigid thresholds), a certification, or a similar representation that indicates a relative likelihood of the individual or organization committing fraud. These scores may be publicly disclosed or kept confidential, depending on their intended use by individuals or organizations. A record of determination 180 is created for the individual person or the organization. This may or may not take the form of issuing a certificate of fraud risk determination. As an option, the underwriting entity 130 is used to conduct an underwriting procedure. That is, the underwriting entity 130 is used to generate and issue, or update, an insurance policy 190 in response to the determination results 174 of the risk evaluation process 120. For example, the individual may be added to an existing policy.

When the decision is made to provide the determination of fraud risk, the risk evaluation entity 105 has found that the risk associated with the individual or organization, with respect to committing fraud, is acceptable. If the decision is made not to provide the determination of fraud risk 170 (i.e., no determination will be provided), the decision must be made whether to investigate the underlying reasons for that decision 175. If the decision is made to investigate, then documented reasons for not providing the determination 172 are generated and forwarded to the investigative entity 140. If the decision is made not to investigate, the process ends 177, and the individual or organization does not receive any fraud risk determination.

In accordance with an embodiment of the present invention, the investigative entity 140 performs an investigation based on the documented reasons for not providing a risk determination 172 and generates a set of investigative results 145. Information from the investigative results 145 may be entered into the risk assessment algorithm 110, along with the personal information disclosure statement 150 and the set of personal information records 160 and other relevant information to generate a second set of risk assessment data 115 (i.e., investigation-based risk assessment data). As part of the investigation, the investigative entity 140 may ask for additional information from the individual(s), or may wish to interview the individual(s).

The second risk assessment data 115 is entered into the fraud risk evaluation process 120. The process 120 evaluates the second risk assessment data 115 to make a new investigated fraud risk determination 170 with respect to the individual(s) or the organization. Based on the additional information from the investigative results 145, the second risk assessment data 115 and, therefore, the decision whether to provide the fraud risk determination 170 may be the same as (i.e., “no”) or different from (i.e., “yes”) the original decision whether to provide the fraud risk determination 170. As a practical matter, there may be a limit to the number of times that an individual or organization will be investigated. That is, at some point, the attempts to determine the fraud risk will be stopped 177.

In accordance with an alternative embodiment of the present invention, personal information records and other relevant information of other persons associated with the individual may be obtained and entered into the risk assessment algorithm 110 along with the individual's information. Such other persons may include, for example, a spouse, a child, a sibling, a business partner, or a parent of the individual. Such information of other persons may be helpful if, for example, an individual were to try to hide embezzled funds in an account held in the name of a close friend or relative.

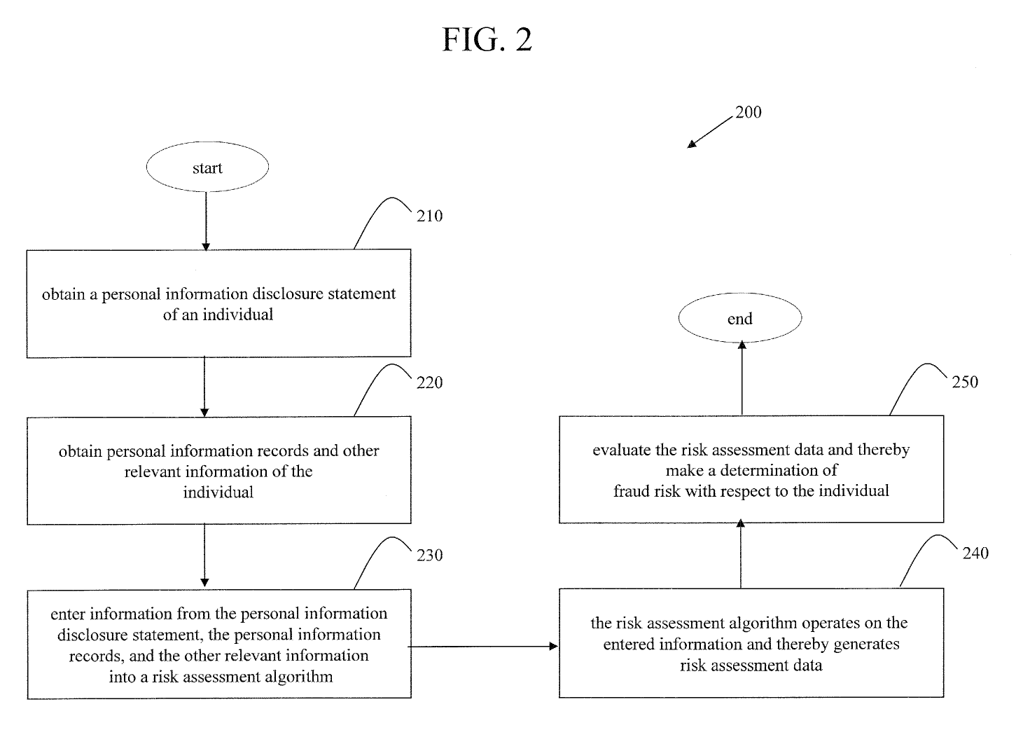

FIG. 2 illustrates a flowchart of a first embodiment of a method 200 which is conducted to help deter and/or detect and/or mitigate fraud by evaluating the propensity of an individual associated with an organization, an individual potentially to be associated with an organization, or an individual acting in his or her individual capacity to commit fraud, using the cooperative arrangement 100 of FIG. 1, in accordance with various aspects of the present invention. In step 210, a personal information disclosure statement of an individual is obtained. In step 220, personal information records and other relevant information of the individual are obtained. In accordance with an embodiment of the present invention, step 220 is performed only if the individual gives permission. In step 230, first information from the personal information disclosure statement, the personal information records, and other relevant information is entered into a risk assessment algorithm. In step 240, the risk assessment algorithm operates on the first input information and thereby generates first risk assessment data. In step 250, the first risk assessment data is evaluated to make a first determination of fraud risk with respect to the individual. In accordance with an alternative embodiment of the present invention, only information from personal information records and other relevant information are used. A personal information disclosure statement may not be obtained.

As an example, referring to FIG. 1, an individual associated with a corporation is to be assessed for fraud risk by the fraud risk evaluation entity 105, In accordance with an embodiment of the present invention, the fraud risk evaluation entity 105 is preferably, but not necessarily, an independent entity which is in the business of assessing the fraud risk posed by individuals of organizations (e.g., publicly held corporations, non-publicly held corporations, government entities). Such fraud risk determinations help to increase the likelihood that the individual will comply with policies, procedures, rules, best practices, ethical and moral standards, and controls of the organization such as, for example, complying with Sarbanes-Oxley regulations. Such a fraud risk determination also helps to ensure that the individual is less likely to engage in fraudulent activities such as, for example, the embezzlement of organizational funds.

Continuing with the example, the individual registers with the risk evaluation entity 105 and provides a personal information disclosure statement 150 to that entity 105. Information provided on the personal information disclosure statement may include, for example, information related the individual's assets (e.g., home ownership), liabilities (e.g., credit card debt), and income (e.g., a salary). The individual also gives permission to the risk evaluation entity 105 to obtain past and present personal information records 160 and other relevant information such as, for example, tax return records, treasury records, real estate records, banking records, or credit reports and scores.

Information is extracted from the personal information disclosure statement 150 and the personal information records 160 and other relevant information and is entered into the risk assessment algorithm 110. The risk assessment algorithm 110 operates on the input information and generates risk assessment data 115. The risk assessment data 115 may include, for example, detected discrepancies found when comparing the individual's personal information disclosure statement 150 and the personal information records 160. For example, a discrepancy between what was claimed as income and what was recorded as income may be found. Also, for example, evidence of irresponsible financial behavior may be detected (e.g., not paying minimum balances due on credit cards), evidence of suspicious/anomalous behavior may be found (e.g., an unusual transfer of funds, a sudden move or change of residence), or financial instability may be detected (e.g., a lender is about to foreclose on the individual's home). Many other risk assessment data are possible as well, in accordance with various embodiments of the present invention. The weighting of these and other factors may vary by design.

Next, the risk assessment data 115 enters the fraud risk evaluation process 120. In accordance with an embodiment of the present invention, the risk assessment data 115 is operated on by the fraud risk evaluation process 120 to generate a fraud risk determination in response to the risk assessment data 115. The fraud risk determination is a reliable indicator of the individual's level of risk with respect to fraudulent activity. In accordance with an embodiment of the present invention, the fraud risk determination may take the form of a quantitative score, a qualitative assignment to a risk category (with flexible and/or rigid thresholds), a certification, or a similar representation that indicates a relative likelihood of the individual or organization committing fraud. In the case where the fraud risk determination is a single numeric value or score, it is compared to a threshold value which is also a numeric value.

If the fraud risk determination is greater than the threshold value, then a decision not to provide the determination is made. If the fraud risk determination is less than the threshold value, then a decision to provide the determination is made. In accordance with an alternative embodiment of the present invention, if the resultant fraud risk determination is within a predefined range of values about the threshold value, a decision to delay providing the determination is made and further action is taken to determine if the fraud risk determination can be lowered (i.e., if the risk can be reduced) in order to make subsequently a decision to provide the determination. Other means of comparing a fraud risk determination are possible as well, in accordance with various other embodiments of the present invention.

In accordance with an alternative embodiment of the present invention, the risk assessment algorithm 110 and the fraud risk evaluation process 120 are implemented as a single algorithm or process. In accordance with an embodiment of the present invention, the risk assessment algorithm 110 and/or the fraud risk evaluation process 120 are both implemented on a processor-based platform such as, for example, a personal computer. In accordance with various embodiments of the present invention, the fraud risk evaluation process 120 may be performed manually by a human, or may be performed automatically by a processor-based platform.

In the case where a decision to provide the fraud risk determination is made, the determination results 174 may be generated and forwarded to the underwriting entity 130, as an option. In accordance with an embodiment of the present invention, the provided information 174 may include, for example, the resultant fraud risk determination and the threshold value used, certain specified personal identification information of the individual and other certain information associated with the individual that were used to generate the fraud risk determination. The underwriting entity 130 may be an insurance company, in accordance with certain embodiments of the present invention, and may be independent of the fraud risk evaluation entity 105 and the investigative entity 140.

In accordance with an embodiment of the present invention, underwriting includes insuring the organization by accepting liability for designated losses arising from fraudulent activities by the individual. The underwriting entity 130 takes the determination results 174 and underwrites the organization by generating or adjusting an insurance policy having terms, conditions, and premium fees which are calculated in response to, at least in part, the determination results 174. This could be part of a wide variety of insurance products, including ones newly created in response to the present invention and ones existing (such as Directors & Officers, Crime, and Fidelity insurance) but improved through the use of the present invention.

For example, if the individual's calculated fraud risk determination is well below the threshold value, then the insurance premium that is to be paid for the insurance policy may be reduced or discounted from a standard rate of someone not having the fraud risk determination or of someone having a higher-fraud risk determination. Also, the terms and conditions of the insurance policy may be more favorable. For example, the amount of time that can pass before the individual is to be re-certified may be longer. Also, monitoring of the individual's future personal information may be less frequent. In accordance with an embodiment of the present invention, the insurance premiums may be paid by the organization of the individual. As a result, the organization may be able to eliminate other forms of insurance coverage.

If new information is obtained on an individual and processed through the fraud risk evaluation entity 105 and the resultant updated fraud risk determination, based on the new information, is better than a previously calculated fraud risk determination, then the underwriting may be updated (i.e., premiums, terms, and/or conditions may be re-calculated) as well based on the improved fraud risk determination. Similarly, if the resultant updated fraud risk determination is worse, then less favorable underwriting premiums, terms, and/or conditions may be provided. For example, updating an underwriting of the organization may be made if a decision is to provide the fraud risk determination and the updated fraud risk determination is closer to the threshold value than a previously calculated fraud risk determination for the individual.

In the case where a decision not to provide the fraud risk determination is made, the decision is made whether to investigate the underlying reasons for that decision 175. If the decision is made to investigate, then documented reasons for not providing the determination 172 are generated and forwarded to the investigative entity 140. In accordance with an embodiment of the present invention, the investigative entity 140 is a private agency or entity with expertise in investigating personal information matters of individuals. The investigative entity 140 takes the documented reasons for not providing the fraud risk determination 172 and determines the underlying circumstances involved and generates corresponding investigation results 145. In accordance with an alternative embodiment of the present invention, the investigative entity 140 is not independent of the fraud risk evaluation entity 105 and/or the organization and may be an integral part of the entity 105, or a branch of the entity 105.

For example, the individual's fraud risk determination may be too risky because the individual is seen to own shares of stock in a competing corporation. Upon investigation, the investigative entity 140 determines that the shares of stock were purchased for the individual as a child by her father many years ago. The individual had forgotten about the shares of stock and, therefore, failed to disclose them on her personal information disclosure statement 150. The investigative results 145 are then forwarded to the fraud risk evaluation entity 105 along with a recommendation that the individual sell the problematic shares of stock. Upon selling the shares of stock, information is extracted from the investigative results 145 and entered into the risk assessment algorithm 110 along with the fact that the individual no longer owns the shares of stock, and along with the information previously extracted from the individual's personal information disclosure statement 150, personal information records 160, and other relevant information.

An updated set of risk assessment results 115 is generated, and an updated fraud risk determination, which is substantially better than the original fraud risk determination, is generated. Upon comparing the updated fraud risk determination to a threshold value, for example, a decision to provide the fraud risk determination for the individual is made. As a result, the individual receives, and/or the individual's organization receives, the determination, and the underwriting process may proceed if desired.

In accordance with an embodiment of the present invention, the risk assessment algorithm 110 takes the input information and generates a set of internal parameters. The risk assessment algorithm then applies weightings to the set of internal parameters and combines the weighted internal parameters in a particular way to generate the risk assessment results 115. Certain weighted internal parameters and/or combinations of weighted internal parameters may be applied to certain internal thresholds in a certain manner to generate particular risk assessment results 115 (e.g., binary risk assessment results).

In accordance with a further embodiment of the present invention, the risk assessment algorithm 110 is a heuristic algorithm that can evolve over time as the risk assessment algorithm 110 is presented with additional information along with output data corresponding to the input information. For example, information from a known first group of individuals who have deliberately not complied with corporate governance rules and procedures and/or who are known to have committed fraud may be entered into the risk assessment algorithm 110 along with the fact that these individuals should not be provided a fraud risk determination (i.e., the algorithm should be able to adapt to generate risk assessment data 115 that detects a problem with this first group of individuals with respect to fraud risk). Similarly, information from a known second group of individuals who have always complied with corporate governance rules and procedures and are known to have not committed fraud may be entered into the risk assessment algorithm 110 along with the fact that these individuals should be provided a fraud risk determination (i.e., the algorithm should be able to adapt to generate risk assessment data that does not detect a problem with this second group of individuals with respect to fraud risk).

Similarly, in accordance with a still further embodiment of the present invention, the fraud risk evaluation process 120 is a heuristic algorithm that can evolve over time as the fraud risk evaluation process 120 is presented with new risk assessment data 115 along with additional data corresponding to the new risk assessment data 115. For example, when presented with the risk assessment data 115 corresponding to the known individuals who deliberately did not comply with corporate governance rules and procedures and who committed fraud, the fraud risk evaluation process 120 may adapt in order to generate correctly a decision not to provide a fraud risk determination 170. Such an adaptation may involve adapting the formula for calculating the fraud risk determination and/or changing a threshold value. Similarly, when presented with the risk assessment data 115 corresponding to the known individuals who always complied with corporate governance rules and procedures and did not commit fraud, the fraud risk evaluation process 120 may adapt in order to generate correctly a decision to provide a fraud risk determination step 170.

Typically, the risk assessment algorithm 110, the risk evaluation process 120, and the fraud risk determination step 170 are allowed to evolve simultaneously in order to take into account new data entered. Such heuristic algorithms may be implemented as, for example, genetic algorithms and/or neural network-based algorithms on processor-based platforms, in accordance with various embodiments of the present invention.

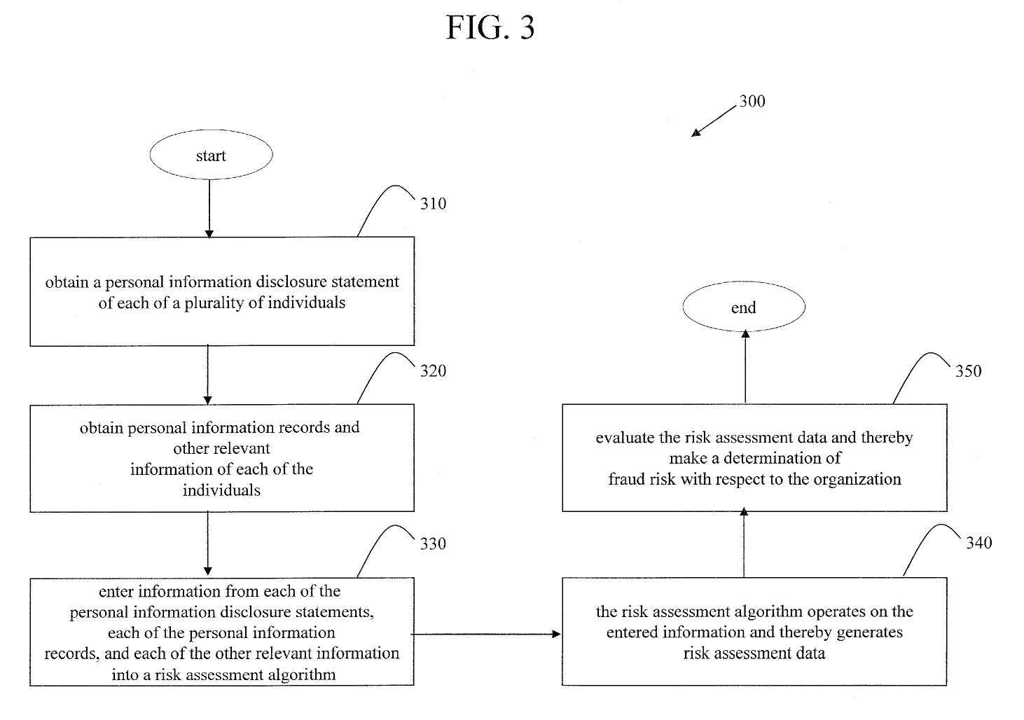

Just as a single individual can receive fraud risk determinations (and be optionally underwritten), an entire organization may also be receive a fraud risk determination (and be optionally underwritten), in accordance with an embodiment of the present invention. FIG. 3 illustrates a flowchart of a second embodiment of a method 300 which is conducted to help deter and/or detect and/or mitigate fraud by evaluating the propensity of an organization to commit fraud, using the cooperative arrangement of FIG. 1, in accordance with various aspects of the present invention. In step 310, a personal information disclosure statement of each of a plurality of individuals associated with an organization is obtained. In step 320, personal information records of each of the individuals and other relevant information are obtained. In step 330, information is extracted from each of the personal information disclosure statements, each of the personal information records, and each of the other relevant information and entered into a risk assessment algorithm. In step 340, the risk assessment algorithm operates on the entered information and thereby generates risk assessment data. In step 350, the risk assessment data is evaluated and thereby a determination of fraud risk is made with respect to the organization.

Therefore, for example, by applying the cooperative arrangement 100 of FIG. 1 to all of the individuals of an organization that handle or have direct or even indirect input to any of the certified financial statements of the organization, the entire organization may receive fraud risk determinations, and become optionally underwritten, as having a lower risk of fraud. Just as for an individual, a fraud risk determination may be generated for the entire organization and compared to a threshold value. The underwriting and/or investigative process illustrated in FIG. 1 may be followed with respect to the entire organization (e.g., a publicly held corporation), based on assessing the risk associated with a plurality of individuals.

Alternatively, the method 200 of FIG. 2 may simply be repeated for each of the individuals of the organization and, therefore, the organization receives the fraud risk determination only after each of those individuals receives individual fraud risk determinations.

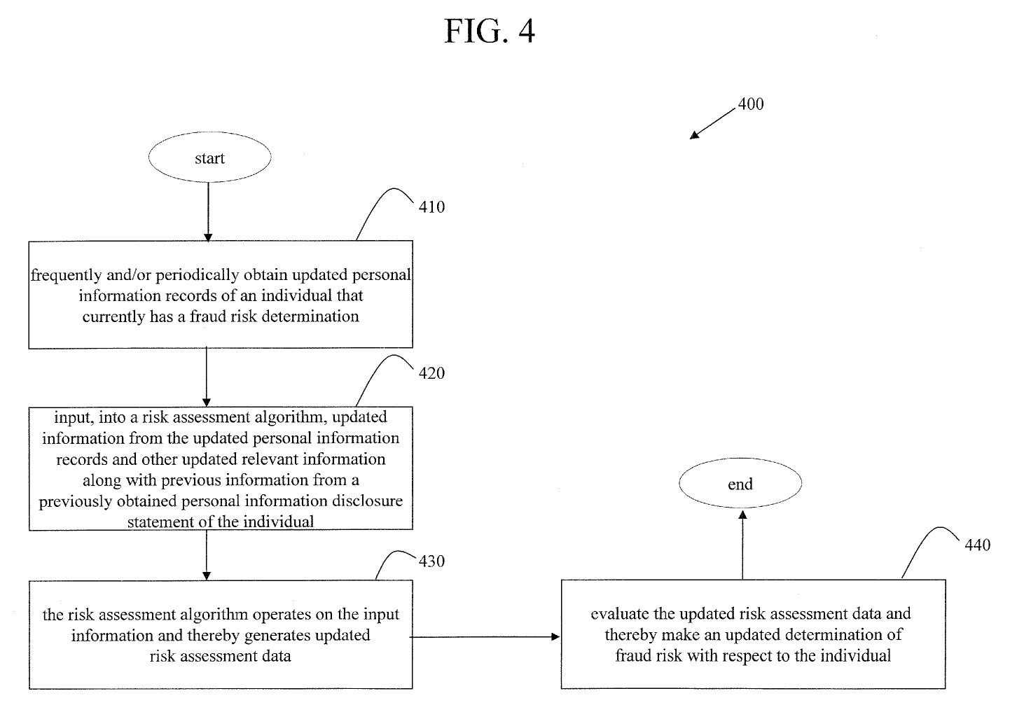

FIG. 4 illustrates a flowchart of an embodiment of a method 400 which is conducted to help deter and/or detect and/or mitigate fraud by monitoring the information of an individual, or a plurality of individuals, associated with an organization, an individual potentially to be associated with an organization, or an individual acting in his or her individual capacity for changes in fraud risk, using the cooperative arrangement of FIG. 1, in accordance with various aspects of the present invention. In step 410 updated personal information records of an individual that currently has a fraud risk determination are frequently and/or periodically obtained. In step 420, updated information from the updated personal information records and other relevant information is input (entered) into a risk assessment algorithm along with information of the individual previously obtained. In step 430, the risk assessment algorithm operates on the input information and thereby generates updated risk assessment data. In step 440, the updated risk assessment data is evaluated and an updated determination of fraud risk is made with respect to the individual.

For example, an individual of a corporation who has a current fraud risk determination and is covered under one of the organization's insurance policies 190 may be required to allow updated (i.e., most-recent) personal information records to be obtained by the fraud risk evaluation entity 105 every fiscal quarter, in accordance with the terms of the corresponding policy 190. As a result, the fraud risk evaluation entity 105 is able to monitor effectively the individual's information to see if any significant changes have occurred that could affect the individual's risk of committing fraud. Another individual of the corporation may be required to provide updated personal information records only once a year, because of the individual's superior fraud risk determination (i.e., lower risk of committing fraud) and superior underwriting status.

In accordance with an alternative embodiment of the present invention, the financial status of an individual may be, effectively, continuously monitored. That is, as soon as updated personal information for an individual becomes available, the information is immediately entered into the risk assessment algorithm and processed. The individual's financial behavior is, in effect, constantly tracked.

If the individual's fraud risk determination deteriorates too much, then the investigative process previously described may be followed. As another example, if the individual's fraud risk determination changes (i.e., improves or degrades but still is acceptable for maintaining the fraud risk determination), the terms, conditions, and/or premiums of the associated underwritten policy for the individual's company may be updated to reflect the changed risk. If no significant changes result, the previous fraud risk determination and underwritten policy may be maintained.

In accordance with an alternative embodiment of the present invention, the individual may provide an updated personal information disclosure statement which is then also used in the monitoring process.

The method 400 of FIG. 4 can also serve as a first indicator of identity theft for the monitored individual. Any unusual activity due to any form of identity theft may be detected by the fraud risk evaluation entity 105, or by the investigative entity 140. For example, if the individual's credit card number were stolen and used in such a way that would be considered unusual for the individual (e.g., sudden fluctuations in the account balance are seen), such an unauthorized use may be detected by the risk assessment algorithm 110.

Employees of the organization for which the individual works may be encouraged to report to the fraud risk evaluation entity 105 any observed misconduct on the part of the individual. In this way, a reporting employee is reporting to an entity which may or may not be independent of his/her employer and, therefore, may be less reluctant to report such misconduct without fear of retaliation from the employer (i.e., from the organization by which the individual and the reporting employee are employed).

In accordance with an alternative embodiment of the present invention, there may be multiple levels or degrees of fraud risk determinations. For example, “gold”, “silver”, and “bronze” levels of certification may be defined based on ranges of possible numeric values that the fraud risk determination can be. As another example, levels of fraud risk determination may be defined based on the number of years that an individual has held a fraud risk determination (e.g., 5-year determination, 10-year determination, etc.).

In accordance with a further alternative embodiment of the present invention, fraud risk determinations may be influenced by the particular position within an organization that an individual holds. For example, the fraud risk determination requirement for a CEO may be different than that for a head of marketing. As another example, the exact risk assessment algorithm used may be somewhat different for a CEO than for a head of marketing.

In accordance with various embodiments of the present invention, fraud risk determinations may be mandatory or may be voluntary. For example, there may be an employee of an organization that is not required to have a fraud risk determination but would like to go through the process (possibly excluding the underwriting part of the process) in order to establish herself as an exemplary person of trustworthiness. Such voluntary participation may be desirable, for example, because it may help the employee gain a promotion into a position of greater responsibility, for example.

As another example, a private employer (i.e., not a publicly held company) may decide that all of his employees must receive fraud risk determinations, in accordance with an embodiment of the present invention, in order to remain or become employed at his private company. That is, in this example fraud risk determination is made a condition of employment. Such a mandatory pre-requisite for employment can allow the private employer to hire and retain only those people that are the least likely to commit fraud.

In summary, a cooperative arrangement and methods of helping to deter, detect, and mitigate fraud are disclosed. Information is collected for individual(s) and entered into a risk assessment algorithm to determine a level of fraud risk with respect to the individual(s) and/or their organization(s). If the level of risk is acceptable, the individual may receive a fraud risk determination and may be optionally underwritten in order to protect the organization against fraud by the individual.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to help deter and/or detect and/or mitigate fraud by evaluating the propensity of an individual, including an individual associated with an organization, an individual potentially to be associated with an organization, or an individual acting in his or her individual capacity, to commit fraud within an organization, said method comprising:
(a) obtaining a personal information disclosure statement of said individual;
(b) obtaining personal information records and other relevant information of said individual;
(c) entering first information from said personal information disclosure statement, said personal information records, and said other relevant information into a risk assessment algorithm;
(d) said risk assessment algorithm operating on said first entered information and thereby generating first risk assessment data; and
(e) evaluating said first risk assessment data and thereby making a first determination of fraud risk with respect to said individual.

2. The method of claim 1 further including providing a fraud risk determination if a decision to provide a fraud risk determination is made.

3. The method of claim 2 further including underwriting said individual if said determination of fraud risk is provided.

4. The method of claim 1 further including documenting reasons for not providing a fraud risk determination for said individual person if said decision not to provide a fraud risk determination is made.

5. The method of claim 4 further including investigating said reasons for not providing a fraud risk determination for said individual person and thereby generating investigative results.

6. The method of claim 5 further including entering second information from said investigative results, said personal information disclosure statement, said personal information records, and said other relevant information into said risk assessment algorithm.

7. The method of claim 6 further including:
said risk assessment algorithm operating on said second input information and thereby generating second risk assessment data; and
evaluating said second risk assessment data and thereby making an updated determination of fraud risk with respect to said individual.

8. The method of claim 1 wherein said individual is an individual of said organization.

9. The method of claim 1 wherein said individual is an individual acting in his or her individual capacity.

10. The method of claim 1 wherein said organization is a publicly held corporation.

11. The method of claim 1 wherein said organization is a non-publicly held corporation.

12. The method of claim 1 wherein said organization is a government entity.

13. The method of claim 1 wherein said organization is a non-governmental organization.

14. The method of claim 1 wherein said personal information records include at least one of tax return records, treasury records, real estate records, banking records, and credit reports and scores.

15. The method of claim 1 wherein said personal information disclosure statement includes information related to at least one of financial assets, liabilities, and income of said individual.

16. The method of claim 3 wherein said underwriting includes insuring said organization by accepting liability for designated losses suffered by said organization arising from fraudulent activity by said individual.

17. The method of claim 2 wherein said method is conducted by a first entity which is independent of said organization and said individual.

18. The method of claim 4 wherein said method is conducted by a first entity which is independent of said organization and said individual.

19. The method of claim 3 wherein said underwriting is conducted by a second entity which is independent of said organization, said individual, and a first entity conducting the steps (a) through (e) of claim 1.

20. The method of claim 5 wherein said investigating is conducted by a third entity which is independent of said organization, said individual, and a first entity conducting the steps (a) through (e) of claim 1.

21. The method of claim 1 wherein the step of said risk assessment algorithm operating on said first input information and thereby generating first risk assessment data includes said risk assessment algorithm comparing information from said personal information disclosure statement with information from said personal information records and other relevant information and thereby detecting any discrepancies.

22. The method of claim 1 wherein the step of said risk assessment algorithm operating on said first input information and thereby generating first risk assessment data includes said risk assessment algorithm detecting evidence of suspicious/anomalous behavior on the part of said individual.

23. The method of claim 1 wherein the step of said risk assessment algorithm operating on said first input information and thereby generating first risk assessment data includes said risk assessment algorithm generating an assessment of propensity of said individual to commit fraud.

24. The method of claim 1 wherein the step of obtaining personal information records and other relevant information of said individual is only conducted if said individual gives permission to perform said step.

25. The method of claim 1 wherein the step of evaluating said first risk assessment data and thereby making a first determination of fraud risk with respect to said individual includes:
generating a fraud risk determination in response to said first risk assessment data; and
comparing said fraud risk determination to a threshold value.

26. The method of claim 25 wherein said determination of fraud risk is provided if said fraud risk determination is below said threshold value.

27. The method of claim 23 wherein said determination of fraud risk is not provided if said fraud risk determination is above said threshold value.

28. The method of claim 26 further including underwriting said individual if said determination is to provide the fraud risk determination, said underwriting including adding said individual to an insurance policy for said organization, or creating a new insurance policy, and possibly adjusting a premium and/or terms of said policy in response to at least said fraud risk determination.

29. A method to help deter and/or detect and/or mitigate fraud by evaluating the propensity of an organization to commit fraud within an organization, said method including:
(a) obtaining a personal information disclosure statement from each of a plurality of individuals associated with said organization;
(b) obtaining personal information records and other relevant information of each of said individual persons;
(c) entering first information from each of said personal information disclosure statements, each of said personal information records, and each of said other relevant information into a risk assessment algorithm;
(d) said risk assessment algorithm operating on said first entered information and thereby generating first risk assessment data; and
(e) evaluating said first risk assessment data and thereby making a first determination of fraud risk with respect to said organization.

30. The method of claim 29 further including providing said organization with a fraud risk determination if said decision is made to provide said fraud risk determination.

31. The method of claim 29 further including underwriting said organization if said determination of fraud risk is provided.

32. The method of claim 29 further including documenting reasons for not providing said fraud risk determination for said organization if said decision is made not to provide said fraud risk determination.

33. The method of claim 32 further including, if so decided, investigating said reasons for not providing said organization with a fraud risk determination, and thereby generating investigative results.

34. The method of claim 33 further including entering second information from said investigative results, said personal information disclosure statements, said personal information records, and said other relevant information into said risk assessment algorithm.

35. The method of claim 34 further including:
said risk assessment algorithm operating on said second input information and thereby generating second risk assessment data; and
evaluating said second risk assessment data and thereby making an updated determination of fraud risk with respect to said organization.

36. The method of claim 29 wherein said individual are individuals of said organization.

37. The method of claim 29 wherein said organization is a publicly held corporation.

38. The method of claim 29 wherein said organization is a non-publicly held corporation.

39. The method of claim 29 wherein said organization is a government entity.

40. The method of claim 29 wherein said personal information records include at least one of one or more of tax return records, treasury records, real estate records, banking records, and credit reports and scores for each of said individuals.

41. The method of claim 29 wherein said personal information disclosure statements includes at least one of information related to financial assets, liabilities, and income of each of said individuals.

42. The method of claim 31 wherein said underwriting includes insuring said organization by accepting liability for designated losses suffered by said organization arising from fraudulent activities by any of said individuals.

43. The method of claim 30 wherein said method is conducted by a first entity which is independent of said organization and said individuals.

44. The method of claim 32 wherein said method is conducted by a first entity which is independent of said organization and said individuals.

45. The method of claim 31 wherein said underwriting is conducted by a second entity which is independent of said organization, said individuals, and a first entity conducting the steps (a) through (e) of claim 29.

46. The method of claim 33 wherein said investigating is conducted by a third entity which is independent of said organization, said individuals, and a first entity conducting the steps (a) through (e) of claim 29.

47. The method of claim 29 wherein the step of said risk assessment algorithm operating on said first entered information and thereby generating first risk assessment data includes said risk assessment algorithm comparing information from said information disclosure statements with information from said corresponding personal information records and said other relevant information and thereby detecting any discrepancies.

48. The method of claim 29 wherein the step of said risk assessment algorithm operating on said first entered information and thereby generating first risk assessment data comprises said risk assessment algorithm detecting evidence of suspicious/anomalous behavior on the part of any of said individuals.

49. The method of claim 29 wherein the step of said risk assessment algorithm operating on said first entered information and thereby generating first risk assessment data includes said risk assessment algorithm generating an assessment of the propensity of said individuals to commit fraud.

50. The method of claim 29 wherein the step of obtaining personal information records and other relevant information of any of said individuals is only conducted if said any individuals give permission to perform said step.

51. The method of claim 29 wherein the step of evaluating said first risk assessment data and thereby making a first determination of fraud risk with respect to said organization includes:
generating a fraud risk determination in response to said first risk assessment data; and
comparing said fraud risk determination to a threshold value.

52. The method of claim 51 wherein said determination of fraud risk is provided if said fraud risk determination is below said threshold value.

53. The method of claim 51 wherein said determination of fraud risk is not provided if said fraud risk determination is above said threshold value.

54. The method of claim 52 further including underwriting said organization if said decision is to provide said fraud risk determination, said underwriting including adding said individuals to an insurance policy for said organization, or creating a new insurance policy, and possibly adjusting a premium and/or terms of said policy in response to at least said fraud risk determination.

55. A method to help deter and/or detect and/or mitigate fraud by monitoring the information of an individual, or a plurality of individuals, associated with an organization, an individual potentially to be associated with an organization, or an individual acting in his or her individual capacity, for changes in fraud risk, said method including:
(a) frequently and/or periodically obtaining updated personal information records and other updated relevant information of an individual that currently has a fraud risk determination;
(b) inputting, into a risk assessment algorithm, updated information from said updated personal information records and other updated relevant information along with previous information from a previously obtained personal information disclosure statement from said individual;
(c) said risk assessment algorithm operating on said input information and thereby generating updated risk assessment data; and
(d) evaluating said updated risk assessment data and thereby making an updated determination of fraud risk with respect to said individual.

56. The method of claim 54 further including maintaining said fraud risk determination of said individual if said decision whether to provide said fraud risk determination is to provide said fraud risk determination.

57. The method of claim 55 further including maintaining an underwriting of said individual if said decision to provide said fraud risk determination is to provide said fraud risk determination.

58. The method of claim 55 further including documenting reasons for not providing said fraud risk determination of said individual if said decision to provide said fraud risk determination is not to provide said fraud risk determination.

59. The method of claim 58 further including investigating said reasons for not providing said fraud risk determination of said individual and thereby generating investigative results.

60. The method of claim 59 further including inputting second information from said investigative results, said personal information disclosure statement, said updated personal information records, and said updated other relevant information into said risk assessment algorithm.

61. The method of claim 60 further including:
said risk assessment algorithm operating on said second input information and thereby generating investigation-based risk assessment data; and
evaluating said investigation-based risk assessment data and thereby making an investigated determination of fraud risk with respect to said individual.

62. The method of claim 55 wherein said organization is a publicly held corporation.

63. The method of claim 55 wherein said organization is a non-publicly held corporation.

64. The method of claim 55 wherein said organization is a government entity.

65. The method of claim 55 wherein said updated personal information records include at least one of most-recent tax return records, most-recent treasury records, most-recent real estate records, most-recent banking records, and most-recent credit reports and scores.

66. The method of claim 55 wherein said personal information disclosure statement includes information related to financial assets, liabilities, and income of said individual person at the time of obtaining said personal information disclosure statement.

67. The method of claim 57 wherein said underwriting includes insuring said organization by accepting liability for designated losses suffered by said organization arising from fraud committed by said individual.

68. The method of claim 55 wherein said method is conducted by a first entity which may be independent of said organization and said individual.

69. The method of claim 56 wherein said method is conducted by a first entity which may be independent of said organization and said individual.

70. The method of claim 57 wherein said underwriting is maintained by a second entity which is independent of said organization, said individual, and a first entity conducting the steps (a) through (d) of claim 53.

71. The method of claim 59 wherein said investigation is conducted by a third entity which may be independent of said organization, said individual, and a first entity conducting the steps (a) through (e) of claim 55.

72. The method of claim 55 wherein the step of said risk assessment algorithm operating on said input information and thereby generating updated risk assessment data includes said risk assessment algorithm comparing information from said information disclosure statement with information from said updated personal information records and said updated other relevant information, and thereby detecting any discrepancies.

73. The method of claim 55 wherein the step of said risk assessment algorithm operating on said input information and thereby generating updated risk assessment data includes said risk assessment algorithm detecting evidence of fraud committed by said individual.

74. The method of claim 55 wherein the step of said risk assessment algorithm operating on said input information and thereby generating updated risk assessment data includes said risk assessment algorithm generating data related to propensity of said individual to commit fraud.

75. The method of claim 55 wherein the step of frequently and/or periodically obtaining updated personal information records and other relevant information of said individual is only conducted if said individual gives permission to perform said step.

76. The method of claim 55 wherein the step of evaluating said updated risk assessment data and thereby making an updated determination of fraud risk with respect to said individual includes:
generating an updated fraud risk determination in response to said updated risk assessment data; and
comparing said updated fraud risk determination to a threshold value.

77. The method of claim 76 wherein said determination of fraud risk is to maintain said fraud risk determination if said updated fraud risk determination is below said threshold value.

78. The method of claim 76 wherein said decision of whether to provide said fraud risk determination is not to provide said fraud risk determination if said fraud risk determination is above said threshold value.

79. The method of claim 76 further including updating an underwriting of said organization if said decision is to provide said fraud risk determination and said updated fraud risk determination is closer to said threshold value than a previously calculated fraud risk determination for said individual.

80. The method of claim 79 wherein said updating said underwriting includes re-calculating a premium and updating terms of insurance in response to at least said updated fraud risk determination.
